(19) United States
(12) Patent Application Publication
(10) Pub. No.: US 2018/0273040 A1
(43) Pub. Date: Sep. 27, 2018

(54) LANE GROOVE EFFECT COMPENSATION

(71) Applicant: Ford Global Technologies, LLC, Dearborn, MI (US)

(72) Inventors: Christoph ARNDT, Moerlen (DE); Anke DIECKMANN, Bad Marienberg / Eichenstruth (DE)

(73) Assignee: Ford Global Technologies, LLC, Dearborn, MI (US)

(21) Appl. No.: 15/928,719

(22) Filed: Mar. 22, 2018

(30) Foreign Application Priority Data
Mar. 27, 2017 (DE) 10 2017 205 074.8

(51) Int. Cl. B60W 30/18; G05D 1/02; B60W 10/18; B60W 10/20; B60W 40/06; G01S 13/93; G01S 17/93

(52) U.S. Cl. CPC B60W 30/18145; G05D 1/0257; G05D 1/0246; B60W 10/18; B60W 10/20; B60W 40/06; G01S 2013/9342; G01S 13/931; G01S 17/936; B60W 2420/42; B60W 2420/52; B60W 2710/18; B60W 2710/20; B60W 30/18109

(57) ABSTRACT

Compensation for an effect of lane grooves in a roadway on driving behavior of a vehicle is performed, wherein lane grooves are detected by a device designed for this purpose such as a stereo camera. Information regarding a character of the lane grooves is transmitted to a control device, and control commands are transmitted by the control device to a steering device of the vehicle, or to actuators of vehicle wheels, in order to counteract the effect of the lane grooves on the driving behavior.

### CROSS-REFERENCE TO RELATED APPLICATIONS

This application claims foreign priority benefits under 35 U.S.C. § 119(a)-(d) to DE Application 10 2017 205 074.8 filed Mar. 27, 2017, which is hereby incorporated by reference in its entirety.

### TECHNICAL FIELD

The disclosure relates to a method to compensate an effect of lane grooves in a roadway on the driving behavior of a vehicle.

### BACKGROUND

Vehicles may encounter road conditions that cannot be readily dealt with by an inexperienced driver. Such road conditions are characterized for example by roadways with lane grooves present longitudinally and/or transversely with respect to the roadway, which lane grooves impair the driving behavior of a vehicle. Strictly speaking, only roadway depressions in the roadway longitudinal direction are referred to as lane grooves; here, however, elongate depressions running transversely with respect to the roadway are also referred to as lane grooves. Lane grooves are characterized in particular by their length, their position in relation to the road or roadway (orientation) and their form, which is determined by the deformation of the surface of the road, that is to say substantially by their width and depth in addition to the length.

Lane grooves arise in particular in asphalted roads. Longitudinal running lane grooves constitute road damage that arises in particular as a result of depression and recompaction of asphalt under the action of high wheel loads of heavy goods vehicles. Transversely running lane grooves arise in particular in the region of traffic signals, stop signs and road intersections, where vehicles, as a result of braking, cause the asphalt to buckle.

Lane grooves lead to disturbances in driving behavior of vehicles, and. thus, burdensome for corresponding drivers. This can also give rise to hazardous situations, for example if water collects in the lane grooves on wet roadways, aquaplaning can occur.

Even under dry conditions, however, longitudinally running lane grooves in particular can give rise to a steering wheel torque and can undesirably influence the steering action intended by the driver. Automatic driving assistance systems such as lane keeping assistants can also be influenced by the action of longitudinally running lane grooves. Transversely running lane grooves influence inter alia the braking distance of a vehicle, which, owing to the depressions, under some circumstances exhibits insufficient ground adhesion for the transmission of the braking force from the wheels to the roadway. Furthermore, the wheels of vehicles are worn non-uniformly by the action of lane grooves, because the lane grooves caused by the wheels of heavy goods vehicles are wider than the wheel width of passenger motor vehicles, for example. It is therefore an object of the disclosure to counteract the influence of lane grooves on the driving behavior in an anticipatory manner.

### SUMMARY

Said object is achieved by a method having the features of the main claim. Advantageous embodiments and refinements of the disclosure will emerge from the coordinate claim, and from the subclaims, from the Figures and from the exemplary embodiments.

A first aspect of the disclosure relates to a method to compensate effects, caused by lane grooves in the surface of a road, on a vehicle travelling on the road, comprising the steps:
detecting lane grooves in a roadway, lying ahead, of the road, before the vehicle reaches the lane grooves, via devices of the vehicle designed for this purpose,
determining a position, form and orientation of the lane grooves in relation to the wheels and the wheelbase of the vehicle,
calculating an influence of depressions on a vehicle taking into consideration an expected vehicle speed in the region of the depressions and the position, form and orientation of the lane grooves,
compensating an effect of the lane grooves via at least one control system of the vehicle.

The method relates in particular to detecting and avoiding lane grooves. However, it is also encompassed by the method that depressions other than lane grooves can also be detected.

The method advantageously permits a permanent adaptation of a control system, and of actuators controlled by the control system, to permanent, random or suddenly occurring roadway unevennesses that interfere with the steering and braking systems of the vehicle. In particular, the method permits an anticipatory calculation of actions of the control system in order to avoid a lane groove, or in order to counteract the effect of a lane groove on a steering behavior of the vehicle, such that a driver does not notice said lane groove. The control system may act on the steering behavior for example via a servo steering assistance system of the vehicle or other suitable actuators. Ideally, action of the control system is not indicated to the driver. In this way, driving comfort is increased, because the driver can control the vehicle through zones with lane grooves without additional expenditure of personal effort with regard to attention and steering.

Vehicles are to be understood in particular to mean land vehicles, in particular motor vehicles, and very particularly four-wheeled motor vehicles.

The devices of the vehicle that serve to detect lane grooves are preferably selected from a group comprising a stereo camera, LiDAR and RADAR devices. Particularly advantageous here is a stereo camera that permits sufficient resolution of the surface structure of the zone of a road lying ahead, that is to say situated in front of the vehicle, and to be reached imminently. LiDAR and RADAR devices are likewise suitable for capturing the surface structure of the road. Here, said devices may also interact in order to detect lane grooves. The LiDAR and/or RADAR devices may for example be used to confirm the information captured by the stereo camera.

The compensation of the effect of the grooves is preferably assisted by a pull-drift compensation facility. Pull-drift compensation is a technology that can identify compensation by a driver with regard to roadway unevennesses or side wind, for example, and automatically apply a corresponding force input using a servo steering assistance system. In this way, it is advantageously the case that, in addition to the grooves in the roadway, further causes of driving interference are counteracted.

Furthermore, the compensation of the effect of the grooves is preferably assisted by at least one vehicle system that is selected from the group comprising a driver assistance system that overtakes maneuvers, a lane keeping assistant, a lane departure warning assistant and devices to compensate pull effects. Robust driving behavior is advantageously effected by interaction of the systems. The stated systems are set such that they function during various driving maneuvers. Furthermore, traffic on other lanes of the road may also be incorporated into the method.

With the method according to the disclosure, lane grooves running both longitudinal and transversely with respect to a direction of travel are detected. It is preferably the case that in particular lane grooves running longitudinally with respect to the direction of travel are detected with the method. Here, it is also possible for exclusively lane grooves running longitudinally with respect to the direction of travel to be detected. The detection of lane grooves running longitudinally with respect to the direction of travel advantageously permits a counteraction of lateral drift, such that the vehicle does not deviate from the direction of travel and the driver does not have to expend force on and pay attention to this.

It is alternatively the case that, preferably, lane grooves running transversely with respect to the direction of travel are detected with the method. Here, it is also possible for exclusively lane grooves running transversely with respect to the direction of travel to be detected. The detection of lane grooves running transversely with respect to the direction of travel permits an adaptation of braking process, for example in terms of timing and force used. It is therefore preferable if, during braking processes, the braking force of the wheels is modulated in a manner dependent on the lane grooves in order to optimize the braking distance.

It is preferable if, in the method, environmental influences including moisture, ice and snow on the roadway are additionally incorporated into the compensation of the effect of the lane grooves. This advantageously works towards, for example, an avoidance of aquaplaning, which can be particularly disadvantageous in lane grooves owing to the relatively large water quantities. Here, it is advantageously determined how much water is present on the road surface, in particular in the lane grooves. The temperatures, in particular in the region of the road surface, are also determined in order to estimate whether moisture that is present is freezing over. Under these conditions, the vehicle is controlled such that its wheels are guided past the lane grooves to the left or to the right.

During cornering, the wheels of the vehicle are preferably kept outside the lane grooves. In this way, the lower adhesion of the wheels on the road surface in corners in relation to straight-head travel is not additionally impaired by the action of the transverse channels.

A second aspect of the disclosure relates to a vehicle having a control system which is designed for carrying out a method according to the disclosure.

### BRIEF DESCRIPTION OF THE DRAWINGS

FIG. 1 is a schematic illustration of an embodiment of a vehicle according to the disclosure on a road with lane grooves.

FIG. 2 shows a flow diagram of an embodiment of a method according to the disclosure.

FIG. 3 shows a view of a road with longitudinal running lane grooves on the right-hand lane.

FIG. 4 is a schematic illustration of a vehicle with wheels in relation to lane grooves in a road.

### DETAILED DESCRIPTION

As required, detailed embodiments of the present disclosure are disclosed herein; however, it is to be understood that the disclosed embodiments are merely exemplary of the disclosure that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present disclosure.

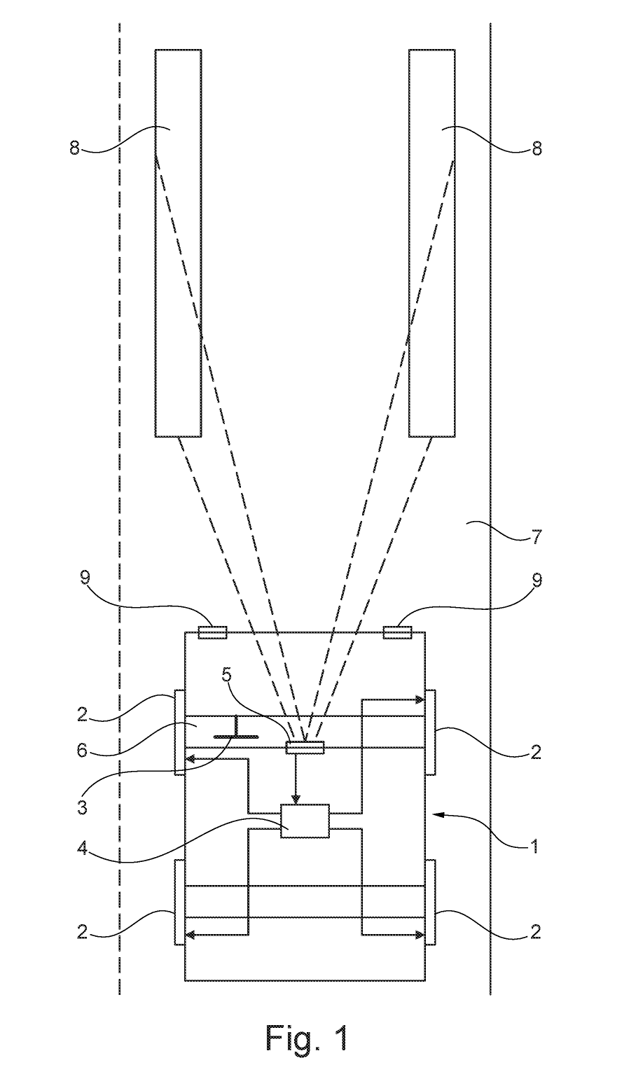

A vehicle 1 according to the disclosure is, in the embodiment illustrated in FIG. 1, a motor vehicle with four wheels 2. For control by a driver, the vehicle 1 has a steering device 3. The vehicle furthermore has a control device 4. The control device 4 is connected to a stereo camera 5 that is arranged in a region of a windshield 6, ideally in an upper region thereof. Alternatively, the stereo camera may also be arranged in other locations of a front region of the vehicle 1. The stereo camera 5 is designed to capture a surface of the road 7 lying ahead of the vehicle in the direction of travel. The arrow denotes the direction of travel of the vehicle 1. It is also possible for multiple stereo cameras 5 to be arranged in the region of the windshield 6 or other locations of the front region of the vehicle 1, for example in a region of headlights 9.

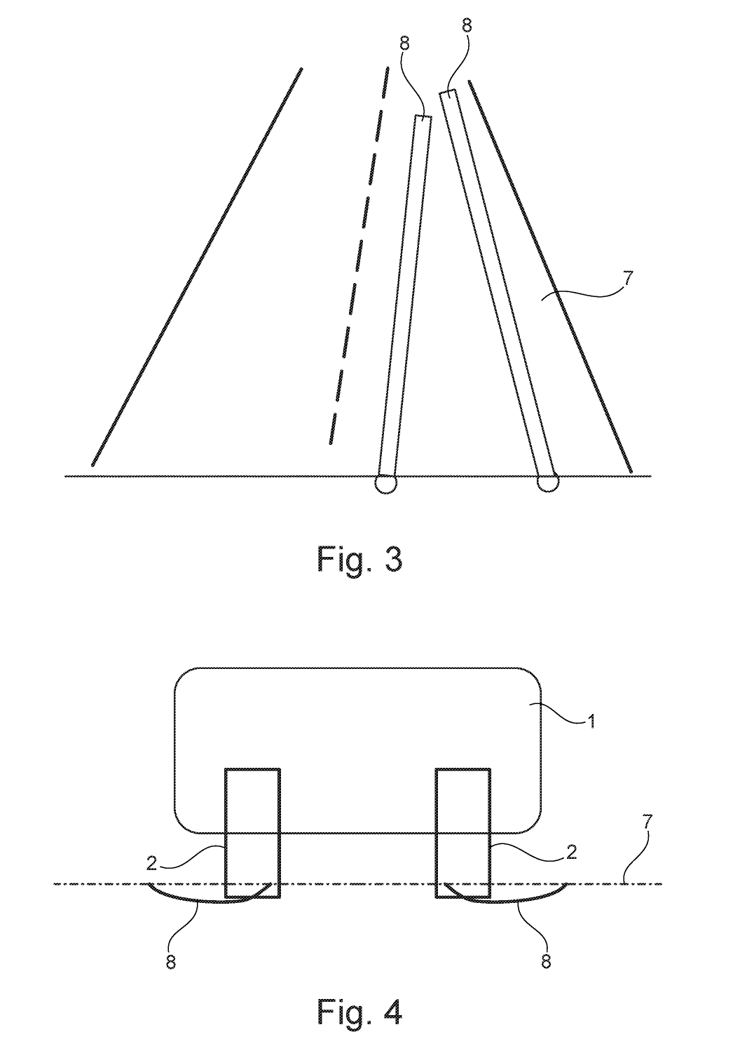

In the direction of travel of the vehicle 1, lane grooves 8 are present in the roadway of the road 7. The lane grooves 8 are characterized by their length, their position in the roadway and their form, that is to say, in addition to the length, substantially by their depth and width. The stereo camera 5 is provided to detect the lane grooves. The lane grooves 8 are oriented longitudinally in FIGS. 1, 3 and 4, that is to say they run substantially along the roadway direction. As illustrated in FIG. 1 on the basis of the right-hand lane groove, it is also possible for longitudinal directed lane grooves 8 to deviate from exactly straight-head direction. This orientation is also detected. According to the disclosure, it is however also possible for transversely directed lane grooves 8 to be detected.

Alternatively or in addition to the stereo camera 5, LiDAR and/or RADAR devices may be arranged in the region of the windshield 6 or other locations of the front region of the vehicle 1. The LiDAR and/or RADAR devices are likewise connected to the control device 4. The control device 4 is furthermore connected to actuators of the wheels 2 and/or of the steering device 3 of the vehicle, and is designed to transmit control commands to the actuators and/or to the steering device, in accordance with the signals received from the stereo camera 5 or from the LiDAR and/or RADAR devices, in order to counteract the action of the lane grooves 8.

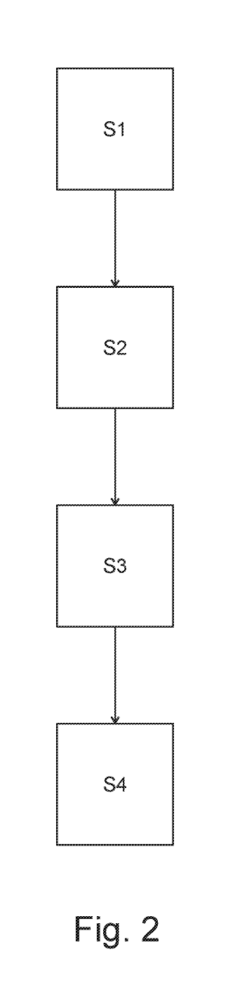

In a method according to the disclosure as per the illustration in FIG. 2 to compensate effects on a vehicle caused by lane grooves 8 in a road 7, in a first step S1, a lane groove 8 is identified by the stereo camera 5. Here, the illustration of FIGS. 1, 3 and 4 involves longitudinal running lane grooves 8. To ensure a sufficient length of time to counteract an expected action of the lane grooves 8 on the wheels 2 and thus on a position of the vehicle 1, the stereo camera 5 is designed to detect the lane grooves 8 at a distance lying sufficiently ahead of the vehicle 1.

In a second step S2, the form, orientation and length of the lane groove 8 is determined. For this purpose, an image of the groove is captured by the stereo camera 5 and is transmitted to the control device 4. Here, the control device 4 also determines a position, form and orientation of the lane grooves 8 in relation to the wheels 2 and the wheelbase of the vehicle 1. Furthermore, in a third step S3, the control device 4 determines the influence of the lane grooves 8 on the vehicle 1 taking into consideration a present vehicle speed, an anticipated vehicle speed in the region of the lane grooves 8, and the position and size of the lane grooves 8. The processing operations to be performed by the control device 4 are known to a person skilled in the art.

In a fourth step S4, an action of the lane grooves 8 when the wheels 2 of the vehicle 1 reach them is compensated. For this purpose, the control device 4 transmits control commands to the actuators of at least one wheel 2, or else of all of the wheels 2, which actuators control the situation and the movement of the wheels 2. Specifically, the wheels 2 are for example steered counter to the direction in which the wheels 2 would, without countermeasures, be steered by the action of the lane grooves. Alternatively or in addition, the control device may directly actuate the mechanism of the steering device 3 in order to influence steering movements by the driver, such that a steering action counter to the direction in which the wheels 2 would, without countermeasures, be steered by the action of the lane grooves 8 is intensified. It is crucial that the operations effected by the action of the control device 4 are performed without the driver being aware. However, the presence of lane grooves 8 and the actions of the control system may also be indicated to the driver, for example by means of a display.

In step S1, the lane grooves 8 may be transversely running lane grooves 8. In addition or alternatively to a steering action, it is also possible in step S3 for the control system 4 to calculate a braking action sufficient to counteract an adverse action of the transversely running lane grooves 8 on the wheels 2 or chassis.

While exemplary embodiments are described above, it is not intended that these embodiments describe all possible forms of the disclosure. Rather, the words used in the specification are words of description rather than limitation, and it is understood that various changes may be made without departing from the spirit and scope of the disclosure. Additionally, the features of various implementing embodiments may be combined to form further embodiments of the disclosure.

What is claimed is:

1. A method to compensate for effects caused by lane grooves in a surface of a road comprising:
detecting, via a device, lane grooves lying ahead of a vehicle on a roadway, before the vehicle reaches the lane grooves;
determining a position, form and orientation of the lane grooves in relation to wheels and a wheelbase of the vehicle;
calculating an influence of the lane grooves on the vehicle considering an expected vehicle speed in a region of the lane grooves, and the position, form and orientation of the lane grooves; and
compensating for the lane grooves, using a pull-drift compensation facility, by steering the wheels counter to a direction indicative of the influence of the lane grooves with a driving assistance system.

2. The method as claimed in claim 1, wherein the device that detects the lane grooves is a stereo camera.

3. The method as claimed in claim 1, wherein the device that detects the lane grooves is a LiDAR device.

4. The method as claimed in claim 1, wherein the device that detects the lane grooves is a RADAR device.

5. The method as claimed in claim 1, wherein the device that detects the lane grooves is configured to detect lane grooves running longitudinally with respect to a direction of travel of the vehicle.

6. The method as claimed in claim 1, wherein the device that detects the lane grooves is configured to detect lane grooves running transversely with respect to a direction of travel of the vehicle.

7. The method as claimed in claim 6 further comprising modulating a braking force of the wheels during braking processes such that a braking distance calculated from the influence of the lane grooves is optimized.

8. The method as claimed in claim 1, wherein the influence of the lane grooves further considers environmental parameters.

9. The method as claimed in claim 1 further comprising keeping the wheels outside the lane grooves during cornering.

10. A vehicle comprising:
a camera disposed on a windshield that detects grooves on a roadway; and
a control device configured to
in response to a position, form and orientation of the grooves in relation to a wheelbase, calculate an influence on each wheel including an expected speed in a region of the grooves, and
in response to the influence, steer the wheels counter to the influence to compensate for the grooves using pull-drift compensation.

11. The vehicle as claimed in claim 10, wherein the control device is further configured to, in response to a braking distance calculated from the influence, modulate a braking force of each wheel during braking processes.

12. The vehicle as claimed in claim 10, wherein the control device is further configured to, in response to cornering detection, keep each wheel outside the grooves.

13. The vehicle as claimed in claim 10, wherein the influence of the grooves further includes environmental parameters.

14. The vehicle as claimed in claim 10, wherein the camera detects grooves oriented longitudinally and transversely with respect to a direction of travel.

15. A driving assistance system comprising:
a LiDAR system disposed on a windshield that detects grooves on a roadway; and
a control device configured to:
in response to a position, form and orientation of the grooves in relation to a wheelbase, calculate an influence on each wheel including an expected speed in a region of the groove, and
in response to the influence, steer the wheels counter to the influence to compensate for the grooves using a pull-drift compensation.

16. The driving assistance system as claimed in claim 15, wherein the control device is further configured to, in response to a braking distance calculated from the influence, modulate a braking force of each wheel during braking processes.

17. The driving assistance system as claimed in claim 15, wherein the control device is further configured to, in response to cornering detection, keep each wheel outside the grooves.

18. The driving assistance system as claimed in claim 15, wherein the influence of the grooves further includes environmental parameters.

19. The driving assistance system as claimed in claim 15, wherein the LiDAR system detects grooves oriented longitudinally with respect to a direction of travel.

20. The driving assistance system as claimed in claim 15, wherein the LiDAR system detects grooves oriented longitudinally with respect to a direction of travel.
